(19) United States
(12) Patent Application Publication
(10) Pub. No.: US 2024/0121708 A1
(43) Pub. Date: Apr. 11, 2024

(54) SELECTION OF AN AVAILABLE NETWORK

(71) Applicant: Telefonaktiebolaget LM Ericsson (publ), Stockholm (SE)

(72) Inventor: Giuseppe BURGARELLA, Santa Clara, CA (US)

(73) Assignee: Telefonaktiebolaget LM Ericsson (publ), Stockholm (SE)

(21) Appl. No.: 18/370,220

(22) Filed: Sep. 19, 2023

Related U.S. Application Data
(63) Continuation-in-part of application No. PCT/IB23/52166, filed on Mar. 7, 2023.
(60) Provisional application No. 63/414,078, filed on Oct. 7, 2022.

(51) Int. Cl. H04W 48/18

(52) U.S. Cl. CPC H04W 48/18

(57) ABSTRACT

A method performed by a communication device for selecting an available network to be an active network for the communication device. The method comprises obtaining a network policy that identifies a set of networks and that identifies at least a first network within the set of networks as a most preferred network, wherein the set of networks comprises a first third-generation partnership project (3GPP) network and a first non-3GPP network. The method also includes determining that the first network is available. The method further includes as a result of determining that the first network is available, setting the first network as the active network for the communication device.

### CROSS-REFERENCE TO RELATED APPLICATIONS

This application is a continuation-in-part of International Patent Application No. PCT/IB2023/052166, filed on Mar. 7, 2023, which claims the benefit of U.S. Provisional Application No. 63/414,078, filed on Oct. 7, 2023. The above identified applications are incorporated by this reference.

### TECHNICAL FIELD

Disclosed are embodiments related to selection of an available network.

### BACKGROUND

A subscription profile (or “profile” for short), such as, for example, a Subscriber Identity Module (SIM) profile, is a collection of data (a.k.a., data package) that contains, among other items, subscription credentials, which include a subscription identifier, such as, for example, a third generation partnership project (3GPP) Subscriber Permanent Identifier (SUPI) or an International Mobile Subscriber Identity (IMSI). The profile may also include another unique identifier, such as an Integrated Circuit Card Identification Number (ICCID).

Generally, a communication device that seeks to gain access to a mobile network needs to have at least one subscriber profile provided by the operator that manages the mobile network to enable the mobile network to determine whether the device is authorized to access the network.

Traditionally, to configure a communication device to be able to access a mobile network, an owner of the communication device enters into a contract with the mobile network operator (MNO) that operates the network and receives in return a SIM card storing a SIM profile containing a subscription identifier. A SIM card is a type of integrated circuit card (ICC)

The SIM card is then physically inserted into a slot in the communication device to allow the device to connect to the MNO's network. If the owner of the device switches their contract to a different MNO, the owner would receive a new SIM card from the new MNO with different subscription credentials and physically replace their old SIM card with the new one.

Thanks to the advent of remote SIM profile provisioning, users no longer need to insert or swap out physical SIM cards. Instead, a Universal Integrated Circuit Card (UICC) can be used, such as, for example, an embedded UICC (eUICC), an integrated UICC (iUICC), or other secure element. Unlike a SIM card that conventionally stores only a single subscriber profile, a UICC can store multiple subscriber profiles.

FIG. 1 illustrates a conventional system 100 for enabling a communication device 102 to obtain and store multiple SIM profiles. The communication device 102 may be any type of device that has the capability to connect to a wireless network. For example, the communication device may be a mobile phone, a smart watch, laptop, a tablet, a cellular Internet-of-Things (cIoT) device, a smart appliance, a smart sensor, etc.

As shown in FIG. 1, communication device 102 includes a conventional Local Profile Assistant (LPA) 104 running within the operating system 106 of device 102. LPA 104 allows the device 102 to interface with SM-DP+ servers.

The LPA 104 may include an interface functionality allowing an end user 118 to interact with the LPA 104. The end user 118 may use the LPA 104 to activate a selected profile to connect to a wireless network provided by a mobile network operator 120.

The LPA 104 may also include discovery functionality that allows the LPA 104 to connect to an Subscription Manager-Discovery Server (SM-DS) 114. The SM-DS 114 may include a root address of a Subscription Manager-Data Preparation+(SM-DP+) 116. The LPA 104 may receive the root address from the SM-DS 114. The LPA 104 may use the root address to connect to the SM-DP+ 116. The SM-DP+ 116 is responsible for storing, creating, and deleting profiles tied to a mobile network operator 120.

The LPA 104 may also include download functionality to enable the LPA service 108 to receive profiles. The LPA service 108 may connect to the SM-DP+ 116 via the LPA 104 in order to download relevant profiles that are stored within the SM-DP+ 116. Once the LPA service 108 receives a profile from the SM-DP+ 116, LPA service 108 stores the profile in a storage unit 110 of secure element 112. The secure element 112 may be a UICC (e.g., an eUICC).

Given today's “work form anywhere” work environment, employers have a challenge to create proper “corporate network” and to manage their employees' communication devices. To this end, corporate information technology (IT) departments employ one (or several) Mobile Device Management (MDM) systems that are available in the market to manage the communication devices. Example MDM systems include Microsoft Intune, AirWatch, Jamf, Citrix, etc. An MDM system can be hosted in the “cloud” or in-house or even offered as a service.

### SUMMARY

Certain challenges presently exist. For example, current communication devices supporting multiple SIM profiles allow for the user of the device to select a profile and enable the selected profile. Corporate IT departments, however, do not want to give their employees ability to manually select whatever mobile network they prefer; instead, the IT departments want the system itself to select the best SIM profile (and, hence, the best network provider). As an example, users at corporate site 1 should connect to a Verizon network and, if there's no Verizon coverage, then connect to an AT&T network. As another example, users at site 2, which is a secure site, should connect to private network to increase security. That is, corporate IT departments want to be the “owners” of this selection; they want to assign just specific SIM profiles (usually from different network providers or from their own private networks) and decide which one shall be used. But, in the current state of the art, it is not feasible for the IT department to manually select a profile for thousands of users, or it may be the case that the communication device is not reachable for lack of coverage, thereby making it impossible for the IT department to remotely configure the device.

In another example, current communication devices prioritize Wi-Fi connections over 3GPP connections. For the average user (e.g., mobile phone user), this preference is reasonable given that Wi-Fi connections tend to be faster than 3GPP connections and many MNO's subscription plans include data caps. Nevertheless, corporate IT departments may not always desire Wi-Fi connections being selected over 3GPP connections. Rather, corporate IT departments may have complex network preferences in which some 3GPP networks are preferred over some Wi-Fi networks but others are not. Given the current state of the art, there exists no way for the IT department to configure a user's communication device with a single consolidated list of preferred networks, which list may include 3GPP networks and non-3GPP networks (e.g., Wi-Fi networks, Ethernet, etc.). For instance, the IT department may prefer a connection to a Verizon 3GPP network (e.g., a Verizon LTE network or Verizon 5G network) over any Wi-Fi connection in the office (e.g., a prive or public Wi-Fi network), but prefer a private IT department managed Wi-Fi connection over a connection to an ATT&T 3GPP network. In the current state of the art, however, such preferences would be impossible to enforce, and the communication device would automatically join the Wi-Fi network over the Verizon network if Wi-Fi connections were enabled in the communication device.

Accordingly, in one aspect there is provided a method performed by a communication device for selecting an available network to be an active network for the communication device. The method includes obtaining a network policy that identifies a set of networks and that identifies at least a first network within the set of networks as a most preferred network, wherein the set of networks comprises a first third-generation partnership project (3GPP) network and a first non-3GPP network. The method also includes determining that the first network is available. The method further includes, as a result of determining that the first network is available, setting the first network as the active network for the communication device.

In another aspect there is provided a computer program comprising instructions which when executed by processing circuitry of a communication device causes the communication device to perform any of the methods disclosed herein. In one embodiment, there is provided a carrier containing the computer program wherein the carrier is one of an electronic signal, an optical signal, a radio signal, and a computer readable storage medium. In another aspect there is provided a communication device that is configured to perform the methods disclosed herein. The communication device may include memory and processing circuitry coupled to the memory.

An advantage of the embodiments disclosed herein is that they provide an efficient and intelligent way for a communicate device to automatically select the best available network. For example, as network conditions change, the communication device can detect this and, in response, automatically select a network that provides a better service. This can decrease latency as well as increase the battery life of the device as the device may not need to use as much power to communicate with the network that provides the better service.

### BRIEF DESCRIPTION OF THE DRAWINGS

The accompanying drawings, which are incorporated herein and form part of the specification, illustrate various embodiments.

FIG. 1 illustrates a conventional system for enabling a communication device to obtain and store multiple SIM profiles.

FIG. 2 illustrates a system for enabling a new communication device to obtain and implement a profile policy.

FIG. 3 is a flow chart illustrating a process, according to an embodiment, for automatically selecting a profile based on a profile policy.

FIG. 4A illustrates a diagram according to an embodiment in which the preferred profile from the profile policy and the active profile being used by the communication device are the same.

FIG. 4B illustrates a diagram according to an embodiment in which the preferred profile from the profile policy and the active profile being used by the communication device are not the same.

FIG. 5 is a flowchart illustrating a process for implementing a profile policy according to an embodiment.

FIG. 6 illustrates a system according to an embodiment in which the communication device is configured to wirelessly communicate with an access point in order to obtain and implement a network policy.

FIG. 7 illustrates a system according to an embodiment that demonstrates the communication device selecting an active network from 3GPP and non-3GPP networks.

FIGS. 8A and 8B are flow charts illustrating a process 800, according to an embodiment, for automatically selecting an available network to be an active network for the communication device.

FIG. 9 a flowchart illustrating a process performed by the communication device for selecting an active network according to an embodiment.

FIG. 10 is a block diagram of a communication device according to an embodiment.

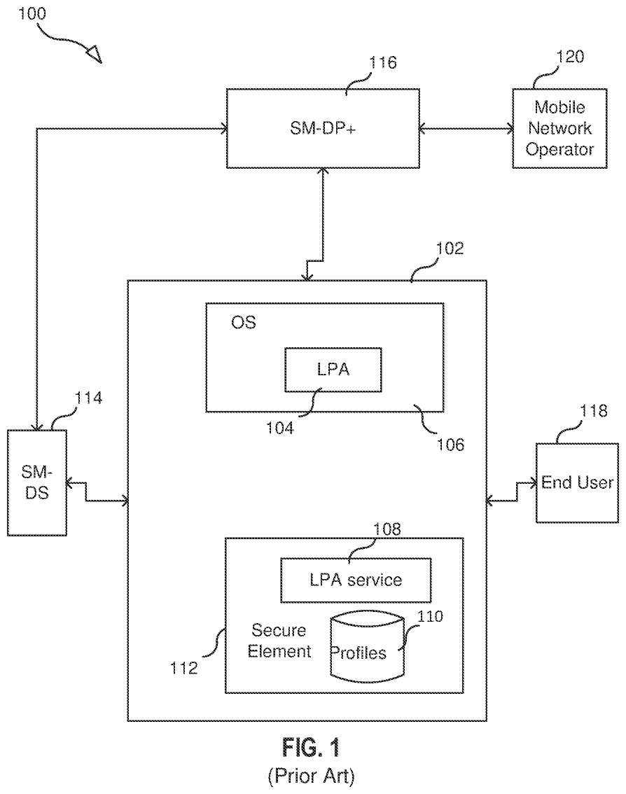

### DETAILED DESCRIPTION

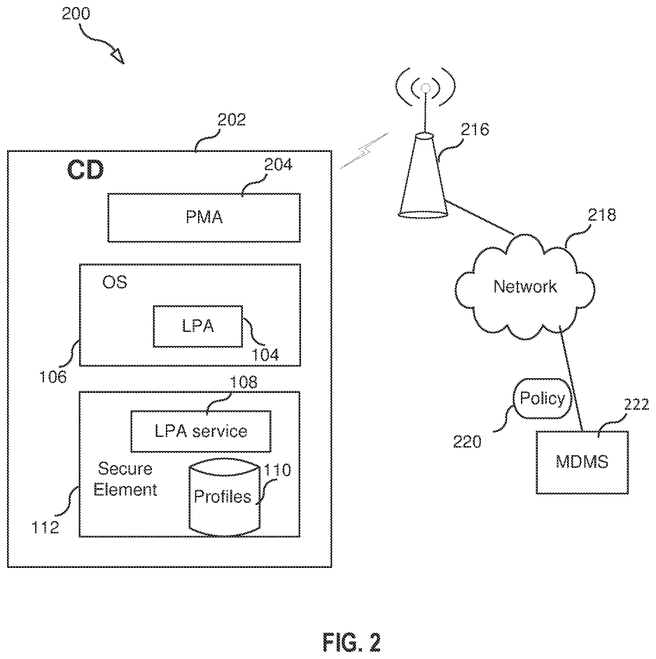

FIG. 2 illustrates a system 200 including a communication device (CD) 202 configured to wirelessly communicate with an access point 216 (e.g., a base station of a radio access network (RAN), a Wi-Fi router, etc.) and to obtain and implement a profile policy 220. Communication device 202 differs from conventional communication device 102 in that communication device 202 has a profile management application (PMA) 204 (a.k.a., “Net-Tune”). In the embodiment shown, PMA 204 is configured to use LPA 104's north-bound interface to interact with LPA 104 to implement profile selection based on the profile policy 220. In some embodiments, the PMA 204 runs on top of operating system (OS) 106 (i.e., in some embodiments, PMA is not a component of OS 106). For example, in some embodiments, a user of device 202 (or an IT administrator) loads PMA 204 onto device 202. In some embodiments, PMA 204 can be a component of LPA 104 or a component of OS 106. In some embodiments, the LPA is a component of the OS of the secure element 112 (e.g., LPA 104 may be a component of LPA service 108) and it is also possible that the PMA is a component of the OS of the secure element 112 (e.g., the PMA may also be a component of LPA service 108).

An MDM system (MDMS) 222 is operable to provide profile policy 220 (or “policy” for short) to communication device 202 via a network 218 (e.g., the internet or a private data network). MDMS 222 can push the profile policy to communication device 202 or communication device 202 can pull the profile policy from MDMS 222 (e.g., device 202 may send a Get policy request to MDMS 222, which then respond by sending a policy to CD 202) In some embodiments, profile policy 220 includes a list of profiles, and, for each profile in the list, priority information indicating a priority assigned to the profile (e.g., the priority information may be a priority value specifying a priority). In some embodiments, the profile policy 220 may include a most preferred profile that is more preferred than any other profile within the profile policy 220 (if there are any).

PMA 204 is operable to request LPA 104 to provide to PMA 204 a list of available profiles. In one embodiment, the available profiles are the profiles that are stored in storage unit 110. The LPA 104 may obtain the list of available profiles from LPA service 108. The LPA 104 may push the list of available profiles to PMA 204 and/or LPA 104 may be configured to provide the list on-demand (i.e., in response to getting a list request from PMA 2024). The list of available profiles may include an active profile indicator indicating which one of the profiles in the list is an active profile (i.e., a profile currently being used by the communication device 202). In another embodiment, the active profile indicator can be retrieved by the PMA from the LPA via a specific interface provided by the LPA.

In one embodiment, PMA 204 uses the profile policy and the active profile indicator to determine whether the active profile is the most preferred profile. If the active profile is the most preferred profile, then PMA 204 monitors the quality of the network identified by the active profile to determine whether the network is “available” (i.e., to determine whether the quality of the network exceeds a threshold). If the network is available, then PMA 204 simply continues to monitor the network. If the network becomes unavailable, then PMA 204 may disable the currently active profile and use information from the profile policy to select a different available profile and then enable that selected profile so that the selected profile becomes the active profile. The selecting of a different available profile is preferably based on the priorities assigned to the available profiles.

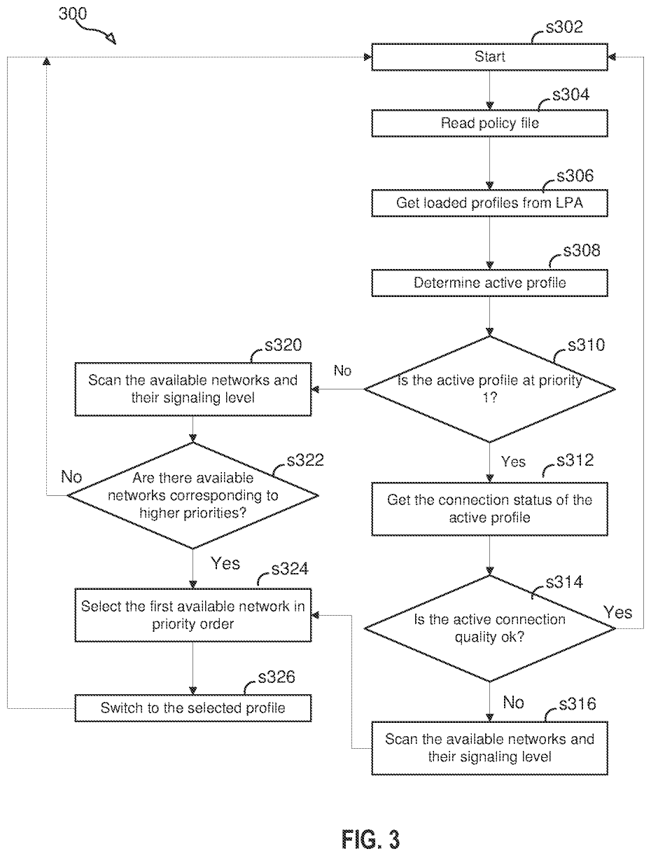

FIG. 3 is a flow chart illustrating a process 300, according to an embodiment, for automatically selecting a profile based on a profile policy. Process 300 may begin at step s302. Step s302 comprises activating PMA 204.

PMA 204 may be activated remotely. In some embodiments, PMA is activated by MDMS 222. In some embodiments, upon activation, PMA pulls a profile policy from MDMS. In other embodiments, PMA will receive the preferred policy along with the activation message. In yet other embodiments, the profile policy may already be stored within the communication device.

At step s304, the PMA reads the profile policy PMA.

At step s306, the PMA obtains the list of available profiles. In some embodiments, the list of available profiles may be obtained from the LPA.

At step s308, the PMA determines which one of the available profiles is the active profile.

At step s310 the PMA determines, based on the profile policy, whether the active profile is the most preferred profile (i.e., the profile among all the available profiles that is assigned the highest priority). If the active profile is not the most preferred profile, then the process proceeds to step s320, otherwise the process proceeds to step s314.

At step s314, the network connection of the network associated with the active profile maybe tested to determine whether the network is available.

In some embodiments, the network is deemed available if the signal quality of the network is greater than or not less than a signal quality threshold. In other embodiments, a multiple network connection quality test may require multiple iterations in order for the network to be available. For example, the network connection quality may have to measure as greater than or equal to a threshold for five consecutive tests in order for a network to be considered available. If the network is considered available, the PMA may designate the active profile to continue to be used by the communication device.

If the network is determined not to be available, the process will move to step s316. At step s316, the PMA may request for other available networks to be scanned to determine if they are available. In some embodiments, the order in which the other available networks are scanned may be based off the profile policy. For example, the profile policy may have a profile that is second in priority. A second network associated with the second profile may then be scanned to determine if the network is available. Next, a third network corresponding to a third profile that is third in priority would be scanned. In another embodiment, PMA scans for all supported frequencies to determine all of networks from which a signal can be received.

At step s324, the PMA may then pick the available network whose corresponding profile has the highest priority. For example, the PMA may pick a second network that corresponds to a second profile that is second in priority if the second network is among the networks that are available.

At step s326, the PMA may message the LPA to switch to the profile that corresponds to the selected network. The LPA may then set the selected profile as active profile of the communication device.

At step s320, as in step s316, other networks are scanned to determine if they are available.

At step s322, the PMA determines whether any of the networks determined to be available correspond to any preferred profiles listed in the profile policy. If no networks corresponding to preferred profiles within the profile policy are available, the PMA may designate the active profile to continue to be used by the communication device.

If at least one available network does correspond to a preferred profile listed in the profile policy, then the process will continue to step s324 and step s326. Steps s324 and 326 may be implemented in the same manner as discussed above.

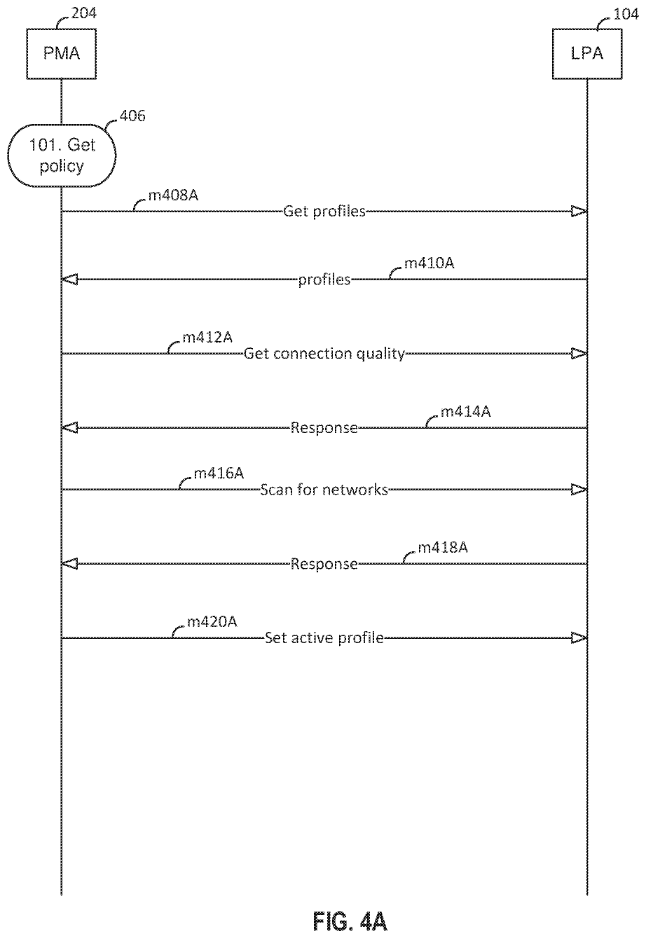

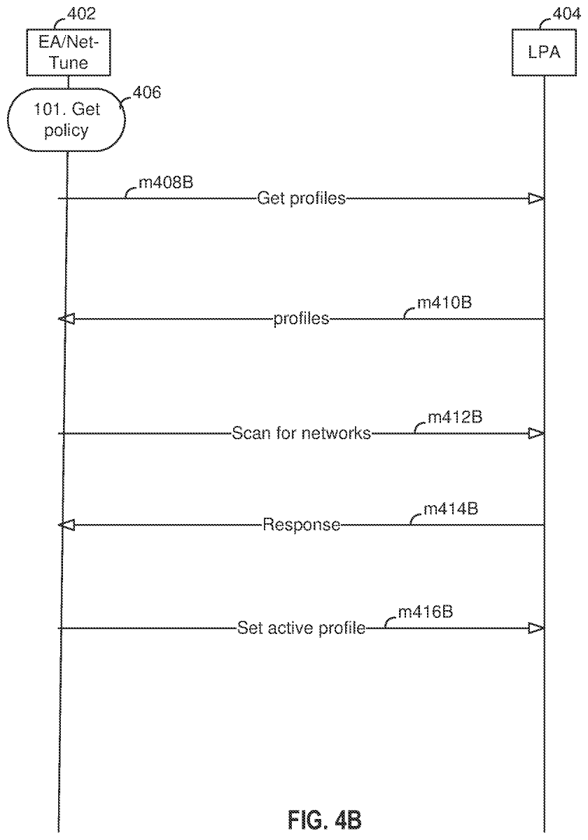

FIG. 4A is a signaling diagram illustrating an embodiment in which the active profile is the most preferred profile.

At step 406, PMA may receive a policy profile A. The profile policy A may be provided by MDMS 222. The profile policy A may include a list of profiles that are given different priority levels. In some embodiments, the profile policy A may include a preferred profile A that is more preferred than any other profile within the profile policy A (if there are any).

At m408A, PMA may send a request to the LPA for the available profiles that are currently stored within the communication device.

At m410A, the LPA may send a response containing the available profiles. In some embodiments, the response may include a designation of an active profile, wherein the active profile is the profile currently being used by the communication device. PMA may determine that the active profile and the preferred profile A are the same. In another embodiment, PMA invoke a specific interface of the LPA to trigger the LPA to return the active profile indicator.

At m412A, PMA may send a message to the LPA requesting the connection quality for the network corresponding to the active profile (which may involve determining whether the network is available). A network may be determined to be available when the connection quality of the network is greater than or not less than a threshold.

At m414A, the LPA may send a response message. In some embodiments, the response message may designate that the network associated with the active profile is available. In such instances, the active profile may remain the profile being used by the communication device.

In other embodiments, the response message may designate that the network associated with the active profile is not available. In such instances, PMA will move to m416A.

At m416A, PMA may send a request message to the LPA to scan for other networks to determine their availability. The requested other networks may correspond the profiles within the profile policy A. In some embodiments, the request for network availability may only include networks that are both within the profiles listed in the profile policy A and available profiles supplied at m410A.

At m418A, the LPA may send a response message. The response message contains a list of networks that are available.

If no other networks are available, PMA may return to m408A. In other embodiments, PMA may return to be being idle.

If other networks are available, PMA may select the available network corresponding to the profile that has the highest priority within the profile policy A.

At m420A, PMA may send a message to the LPA to select the highest priority profile within the profile policy A that has an available network.

FIG. 4B is a signaling diagram illustrating an embodiment in which the active profile is not the most preferred profile.

At 406, PMA may receive a profile policy B that contains a preferred profile B that is the most preferred profile of profile policy B. The preferred profile B may differ from the preferred profile A in FIG. 4A.

The enhancement application may send the same profile request at m408b as m408a in FIG. 4A.

The message sent by the LPA at m410b may be similar to that sent at m410a in FIG. 4A. But at m410b, PMA may determine that the active profile used by the communication device and the preferred profile B are not the same.

At m412b, PMA may send a request message to the LPA to scan for other networks to determine their availability. The requested other networks may correspond the profiles within the profile policy. In some embodiments, the request for network availability may only include networks that are both within the profiles listed in the profile policy B and available profiles supplied at m410B.

At m414B PMA may send a response message. The response message contains a list of networks that can be detected, and, for each detected network, information on the quality of the network (e.g., signal power) so that the PMA can determine whether the network has good enough quality (i.e., whether the network is “available”).

If no other networks are available, PMA may return to m408A. In other embodiments, PMA may return to be being idle.

If other networks are available, PMA may select the available network corresponding to the profile that has the highest priority with the profile policy B.

At m420A, PMA may send a message to the LPA to select the highest priority profile within the profile policy B that has an available network.

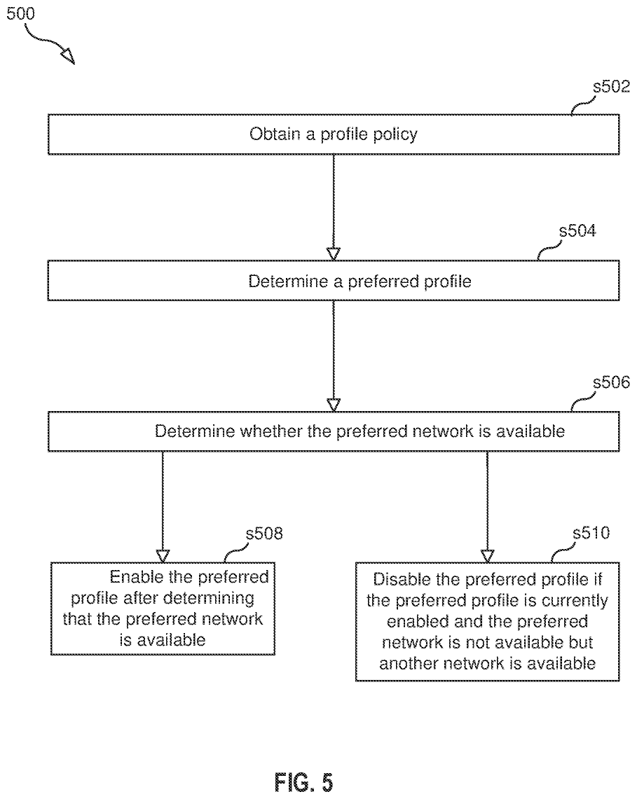

FIG. 5 is a flowchart illustrating a process 500 performed by communication device 202, which as noted above, comprise a secure element 112 (e.g., an eUICC or other tamper proof element) storing a set of available profiles (e.g., a set of two or more SIM profiles), the set of available profiles comprising a first profile and a second profile. Process 500 may begin with step s502.

Step s502 comprises PMA 220 obtaining a profile policy. The profile policy may identify a set of one or more profiles and may further indicate, for each identified profile, a priority assigned to the profile. Accordingly, one profile within the profile policy may be designated as the most preferred profile (e.g., the profile assigned a priority value of 1).

In some embodiments, PMA 220 may take into consideration its current geographic location when obtaining a policy in step s502. For example, communication device 202 may store a number of profiles, where each profile is associated with a different geographic region. Accordingly, in some embodiments, in step s502 the PMA first determines its current geographic region and then selects the profile that is associated with the current geographic region. Hence, in some embodiments, MDMS 222 pushes several profile policies to PMA 202, where each one of the several profile policies is associated with a different geographic region. In one embodiment, if the PMA is not able to determine its location, it can just select a default policy or assume that its location has not changed since the last time its location was determined.

Step s504 comprises, based on the profile policy, determining a preferred profile from among the available profiles, wherein the preferred profile identifies a preferred network.

Step s506 comprises, after determining the preferred profile, determining whether the preferred network is available (e.g., the network is available so long as the quality of the preferred network is greater than threshold or not less than a threshold).

Step s508 comprises enabling the preferred profile after determining that the preferred network is available. In some embodiments, before enabling the preferred profile, the PMA determines whether the communication device has an active session that is internet dependent (e.g., a session that would be terminated automatically if the communication device's IP address were to change). If the communication device has such an active session, the PMA may wait until after the session has ended before enabling the preferred profile. For example, the PMA may determine that the preferred network is available and that the preferred profile is not enabled, but that the communication device is currently streaming or downloading a video or uploading a video. The PMA may recognize that the communication device is streaming video and wait until after the communication device is done streaming the video to switch to the preferred profile (assuming the network is still available at that time). That is, when the data traffic has stopped, the PMA will check whether the preferred network is available, and, if it is, switch to the preferred profile.

Step s510 comprises, after determining that the preferred network is not available, disabling the preferred profile. For instance, in one embodiment, the preferred profile is disabled if the preferred network is not available and the preferred profile is currently enabled (assuming another network is available). In some embodiments, before disabling the preferred profile, the PMA determines whether the communication device has an active session that is internet dependent. If the communication device has such an active session, the PMA may wait until after the session is complete before disabling the preferred profile (assuming that the preferred network is not available at that time).

In one example, a corporation may have a MDM system comprising a plurality of communication devices. The corporation may prefer that the communication devices connect to profile. A corresponding to a network A. If profile A is not available, however, the corporation may prefer that user devices connect to profile B corresponding to a network B. These preferences may be put into a profile policy, wherein profile A is the most preferred profile and profile B is the second most preferred profile.

The MDM operator may transfer the profile policy to one or more communication devices connected to the MDM system. The PMA within a communication device may receive the profile policy and determine that profile A is the most preferred profile. The PMA may next determine whether network A is available. The device may determine whether network A is available by determining that its network connection strength is above or equal to a threshold.

If network A is available, then the PMA may next determine whether profile is currently being used by the device. If the profile A is currently being used by the device then profile A may remain as the active profile. If profile A is not currently the active profile then the PMA may select profile A to be the active profile of the device.

If the network determines that network A is not available then the PMA may determine whether profile A is the active profile currently being used by the device. If profile A is the current profile being actively used by the device then the PMA may switch to a different profile such as profile B.

In some embodiments, the communication device will first check if the network corresponding to profile B is available before switching to profile B. In other embodiments, the active profile of the communication device may remain the same.

If profile A is not the active profile of the device and the network A is not available, then the PMA may not switch the active profile. In other embodiments, the communication device may switch the active profile to be profile B if it determines that the network corresponding with profile B is available.

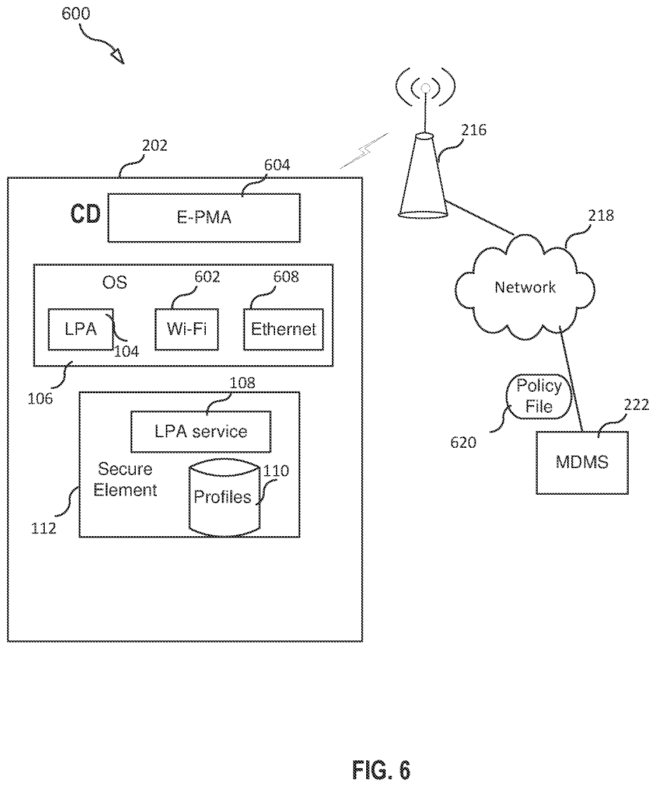

FIG. 6 illustrates a system 600 in which CD 202 is configured to wirelessly communicate with the access point 216 in order to obtain and implement a network policy 620. In some embodiments, the network policy 620 can identify a set of networks, and, for each network within the set, priority information indicating a priority assigned to the identified network (e.g., the priority information may be a priority value specifying a priority). In some embodiments, the network policy 620 can include a most preferred network that is more preferred than any other network within the network policy 620 (if there are any). In some embodiments, similar to profile policy 220, the network policy 620 can include a list of profiles that identify 3GPP networks. In some embodiments, the network policy 620 may identify non-3GPP networks such as Wi-Fi. In some embodiments, the network policy 620 may also identify whether an Ethernet network for CD 202 is allowed.

In some embodiments, CD 202 in system 600 is configured to include an enhanced profile management application (E-PMA) 604 (a.k.a E-Net-Tune). Similar to PMA 204, as shown in FIG. 2, E-PMA 604 is configured to use LPA 104's north-bound interface to interact with LPA 104 to implement profile selection based on the profile policy 220. Additionally, E-PMA 204 is further configured to interact with the Wi-Fi card 602 (e.g., Wi-Fi NBI) of CD 202 and the Ethernet Card 608 (e.g., Ethernet NBI) of CD 202. In some embodiments, E-PMA 604 can cause the Wi-Fi card to scan available Wi-Fi networks. In some embodiments, E-PMA 604 may also be able to disable the Wi-Fi card so as to prevent CD 202 from being able to join a Wi-Fi network. In some embodiments, E-PMA 604 can disable or enable the Ethernet card to prevent or enable CD 202 from being able to use an Ethernet network. In some embodiments, E-PMA 604 runs on top of operating system (OS) 106 (i.e., in some embodiments, E-PMA 604 is not a component of OS 106). For example, in some embodiments, a user of device 202 (or an IT administrator) loads E-PMA 604 onto device 202. In other embodiments, E-PMA 604 can be a component of OS 106.

In some embodiments, MDMS 222 is operable to provide the network policy 620 to CD 202 via the network 218. MDMS 222 can push the network policy 620 to CD 202 or CD 202 can pull the policy from MDMS 222 (e.g., CD 202 may send a Get policy request to MDMS 222, which then respond by sending a policy to CD 202).

E-PMA 604, similar to PMA 204, is operable to request LPA 104 to provide to E-PMA 604 a list of available profiles. In one embodiment, the available profiles are the profiles that are stored in storage unit 110. The LPA 104 may obtain the list of available profiles from LPA service 108. The LPA 104 may push the list of available profiles to E-PMA 604 and/or LPA 104 may be configured to provide the list on-demand (i.e., in response to getting a list request from E-PMA 604). The list of available profiles may include an active profile indicator indicating which one of the profiles in the list is an active profile (i.e., a profile currently being used by the communication device 202). In another embodiment, the active profile indicator can be retrieved by E-PMA 604 from the LPA 104 via a specific interface provided by the LPA 104.

In one embodiments, E-PMA 604 may disable 3GPP connection capabilities for CD 202 if the at least one 3GPP network is not identified within the network policy 620. In some embodiments, disconnecting the 3GPP connection capabilities of CD 202 may include removing any current active profiles from being active profiles. In other embodiment, E-PMA 604 may enable 3GPP connection capabilities of CD 202 if at least one 3GPP network is identified within the network policy 620. In some embodiments, E-PMA 604 may disable the Wi-Fi card of CD 202 if at least one 3GPP network is identified within the network policy 620. In some embodiments, E-PMA 604 may enable the Wi-Fi card if at least one Wi-Fi network is included within the network policy 620. In some embodiments, E-PMA 604 may, by default, disable the Ethernet card of CD 202 and only enable the Ethernet card if the network policy 620 indicates that Ethernet networks are allowed.

In some embodiments, E-PMA 604 may determine whether the active network is the most preferred network. If the active network is the most preferred network, then E-PMA 604 monitors the quality of the network in order to determine whether the network is “available” (i.e., to determine whether the quality of the network exceeds a threshold). If the network is available, then E-PMA 604 simply continues to monitor the network. If the network becomes unavailable, then E-PMA 604 may select a different available network and enable that selected network so that the selected network becomes the active network. The selecting of active networks is preferably based the priorities assigned to the available networks.

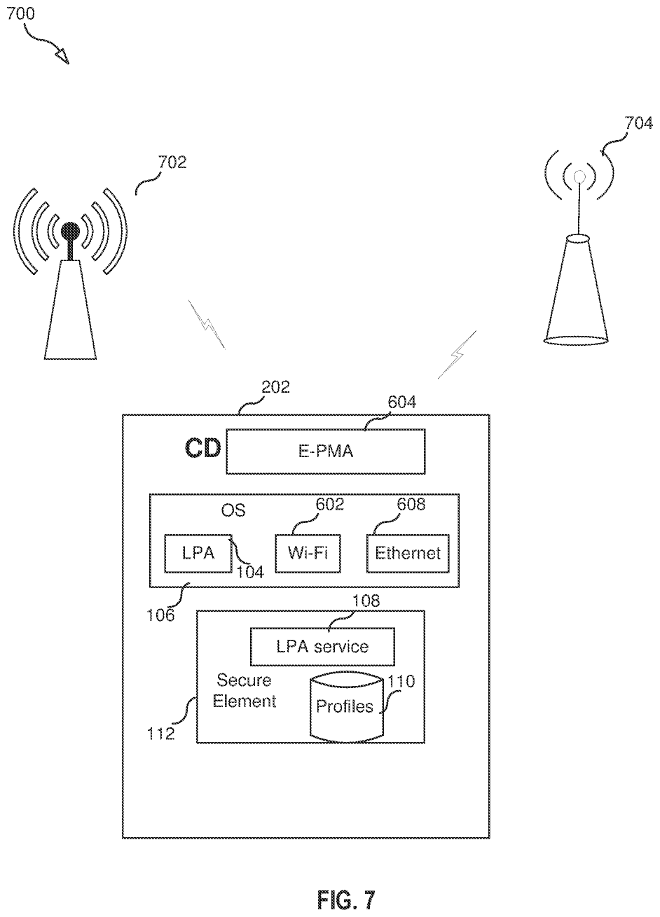

FIG. 7 illustrates a system 700 that demonstrates CD 202 selecting an active network from 3GPP and non-3GPP networks. In some embodiments, the system 700 may include a base station 702 (e.g., a base station of a radio access network (RAN)) for connecting to a 3GPP network and a router 704 (e.g., a Wi-Fi router) for connecting to a non-3GPP network.

In some embodiments, after receiving a network policy 620 (either from the MDM 222 or from CD 202), E-PMA 604 may read the network policy 620 and determine that at least one 3GPP network is identified in the network policy 620. If the 3GPP connection capabilities are not enabled within CD 202, E-PMA may enable the 3GPP connection capabilities (e.g., enable the radio modem) of CD 202. In some embodiments, if CD 202 does not have an active profile, E-PMA 604 may set one of the profiles to be the active profile. In other embodiments, E-PMA 604 may only enable a profile, when no profiles are enabled, if the network associated with the profile is determined to be set as the active network. In some embodiments, E-PMA 604 may set the active profile to be the profile which has the highest priority from among the profiles which identified networks were determined to be available.

In other embodiments, E-PMA 604 can read the network policy 620 and determine that no 3GPP network is identified in the network policy 620. In response to the determination, E-PMA 604 may disable the 3GPP connection capabilities (e.g., disable the radio modem) of CD 202. In some embodiments, disabling the 3GPP connection capabilities of CD 202 may include removing any active profile of CD 202 from being an active profile.

In some embodiments, the network policy 620 can identify at least one non-3GPP network such as Wi-Fi (or Bluetooth). Based on the indication of non-3GPP networks, E-PMA 604 may enable the Wi-Fi card if the Wi-Fi card is not already enabled (or enable the Bluetooth card if the Bluetooth card is not already enabled). In other embodiments, the network policy 620 may not identify at least one non-3GPP network such as Wi-Fi (or Bluetooth). Based on the indication, E-PMA 604 may disable the Wi-Fi card of CD 202 if not already disabled (or disable the Bluetooth card if the Bluetooth card is not already disabled). This may help prevent CD 202 from joining networks not identified in the network policy 620.

In some embodiments, the network policy 620 includes an indication of whether Ethernet networks are allowed. In some embodiments, based on the indication, E-PMA 604 can enable Ethernet networks for CD 202 (e.g., enable the Ethernet card) if Ethernet networks are allowed and disable Ethernet networks for CD 202 (e.g., disable the Ethernet card) if Ethernet networks are not allowed. In some embodiments, E-PMA 604 may, by default, disable Ethernet networks for CD 202 and only enable Ethernet networks if the network policy 620 identifies that Ethernet networks are allowed.

In some embodiments, the network policy 620 may include a priority indication for each network identified in the network policy 620. In some embodiments, E-PMA 620 may determine that the current active network of CD 202 is not the network with the highest priority in the network policy 620. Based on the determination, E-PMA 620 may search for other available networks identified in the network policy 620. If no other network is available with a higher priority than the current active network, the current active network may remain as the as the active network (provided that the connection strength of the current active network meets a threshold). If a network is available and of higher priority than the current active network, E-PMA 604 may set that network as the new active network. In some embodiments, the new active network is a 3GPP network and the previous active network is a Wi-Fi network. Accordingly, CD 202 may disconnect from the router 704 and connect to the new active network through the base station 702. In some embodiments, prior to selecting the 3GPP network as the new active network, CD 202 may determine the connection strength of the 3GPP network from the base station 702. In some embodiments, the signal strength of the 3GPP network may be determined without connection to the 3GPP network.

In other embodiments, the new active network is a Wi-Fi network and the previous active network is a 3GPP network. Accordingly, CD 202 may disconnect from the base station 702 and connect to the new active network through the router 704. In some embodiments, prior to selecting the Wi-Fi network as the new network, CD 202 may disconnect from the base station 702 and connect to the router 704 in order to determine the connection strength of the Wi-Fi network.

In one embodiment, a network policy 620 received by CD 202 identifies a first 3GPP network (e.g., T-Mobile), a second 3GPP network (e.g., Verizon), a first non-3GPP network (e.g., Wi-Fi 1), and a second non-3GPP network (e.g., Wi-Fi 2). The network policy 620 may also include a priority ranking for each network such that the first 3GPP network is ranked first in priority (e.g., most preferred), the first non-3GPP network is ranked second in priority, the second 3GPP network is ranked third in priority, and the second non-3GPP network is ranked fourth in priority.

E-PMA 604 may read the network policy 620 and determine that at least one 3GPP network is identified in the network policy 620. E-PMA 604 may then load the profiles stored within CD 202. E-PMA 604 may then compare the current active profile with the most preferred profile (e.g., profile that identifies the first 3GPP network) and determine that the most preferred profile is not the active profile. E-PMA 604 may then determine whether the first 3GPP network is available. After determining that the first 3GPP network is available, E-PMA 604 may set the most preferred profile to be the active profile and cause the first 3GPP network to be the active network. In some embodiments, CD 202 may connect to first 3GPP network through the base station 702 in order to determine if the first 3GPP network is available. In other embodiments, CD 202 may connect to the first 3GPP network through the base station 702 after the first 3GPP network is set as the active network.

In a further embodiment, after certain amount of time, CD 202 may determine that the first 3GPP network is no longer available. CD 202 may then determine whether the next most preferred network is available (e.g., the first non-3GPP priority). If the first non-3GPP network is available, E-PMA 604 may set the first non-3GPP network to be the active network. In some embodiments, CD 202 may connect to the first non-3GPP network through the router 704 in order to determine if the first non-3GPP network is available. In other embodiments, CD 202 may connect to the first non-3GPP network after setting the first non-3GPP network as the active network.

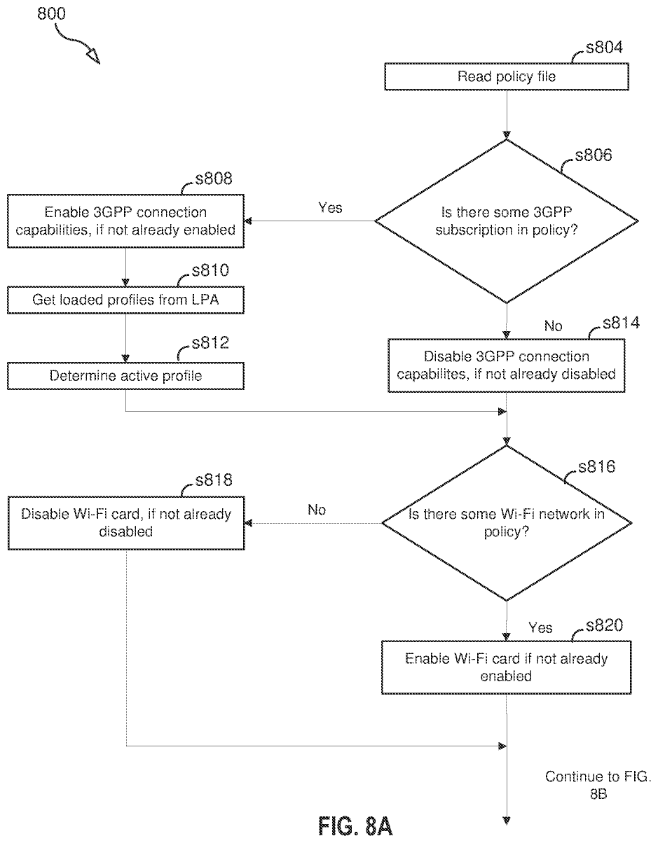

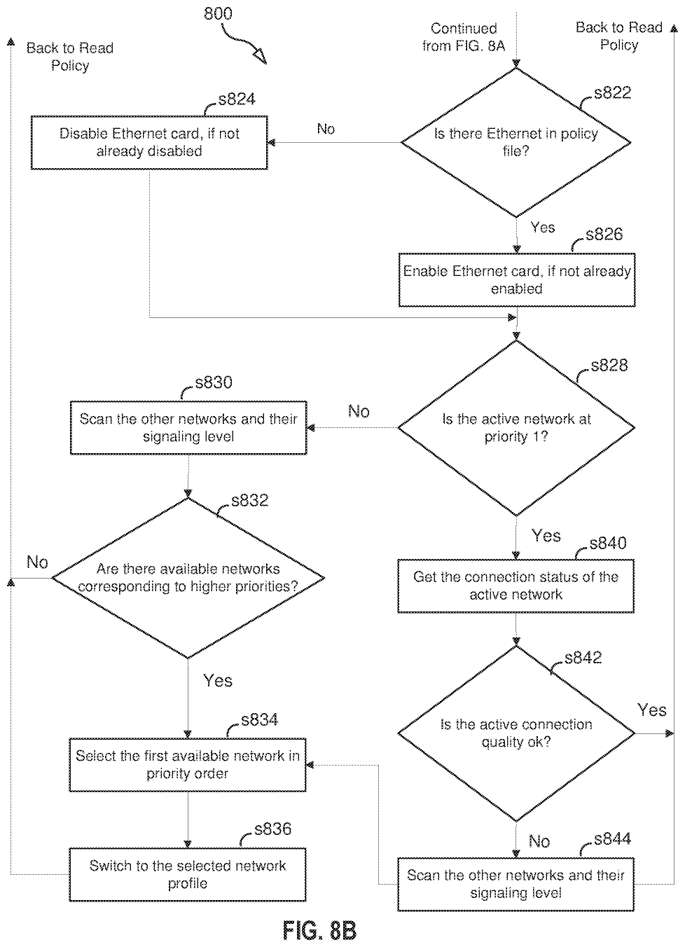

FIGS. 8A and 8B are flow charts that illustrate a process 800, according to an embodiment, for automatically selecting an available network to be an active network for the communication device.

In some embodiments, E-PMA may begin the process based on E-PMA being activated by MDMS. In some embodiments, upon activation, E-PMA pulls a network policy from MDMS. In other embodiments, E-PMA will receive the network policy along with the activation message. In yet other embodiments, the network policy may already be stored within the communication device.

At step s804, E-PMA reads the network policy that identifies a list of networks. In some embodiments, the network policy identifies 3GPP and non-3GPP networks. For example, the identified 3GPP network may include Verizon and T-Mobile and identified the non-3GPP networks may include Wi-Fi networks. In other embodiments, the network policy may only identifies 3GPP networks. In yet other embodiments, the network policy may only identifies non-3GPP networks such as Wi-Fi. In some embodiments, the network policy may include one or more profiles each of which identifies a 3GPP network. In some embodiments, the network policy may include an indication on whether Ethernet use is allowed. In some embodiments, E-PMA may be configured to disable the Ethernet card of CD 202 by default (e.g., before any profile policy is read). This may prevent CD 202 from connecting to a network via Ethernet by default

At step s806, E-PMA determines whether the network policy includes at least one 3GPP network. If the network policy includes a 3GPP network, process 800 proceeds to step s808. If the network policy does not include a 3GPP subscription profile, the network proceeds to step s814.

At step s808, E-PMA enables 3GPP connection capabilities, if not already enabled. In some embodiments, the 3GPP connection capabilities may have been previously disabled. This may be due to a previous network policy not including a 3GPP connection.

At step s810, E-PMA loads profiles from LPA. In some embodiments, the profiles may be stored and loaded from a secure element within CD 202.

At step s812, E-PMA determines which profile is active. In some embodiments, CD 202 may not currently have an active profile. In further embodiments, E-PMA may set a profile to be the active profile. In some embodiments, E-PMA may set the most preferred profile (e.g., profile which identifies the most preferred 3GPP network) as the active profile. In some embodiments, E-PMA may be configured to set some other profile as the default active profile. In other embodiments, E-PMA may not determine whether to set an active profile for CD 202 until step s828.

At step s814, E-PMA disables 3GPP connection capabilities of CD 202, if it is not already disabled. This prevents CD 202 from joining unwanted 3GPP networks outside of the networks identified by the network policy. In some embodiments, E-PMA may disconnect the 3GPP connection capabilities of CD 202 disabling any active profiles of CD 202 so that CD 202 no longer has an active profile.

At step s816, E-PMA determines whether at least one Wi-Fi network is identified in the network policy. In some embodiments, E-PMA may also determine whether any other non-3GPP network (e.g., Bluetooth) is identified. If the network policy does not include a Wi-Fi network, process 800 proceeds to step s818. If the network policy does include a Wi-Fi network, process 800 process to step s820.

At step s818, E-PMA disables the Wi-Fi card within CD 202 if not already disabled. This prevents CD 202 from joining unwanted Wi-Fi networks outside of the networks included within the network policy.

At step s820, E-PMA enables the Wi-Fi card within CD 202, if not already enabled. This allows CD 202 to connect to Wi-Fi networks.

At step s822, E-PMA determines whether an Ethernet network is included within the network policy. If PMA determines the network policy does include an Ethernet network, process 800 proceeds to step s824. If PMA determines the network policy does include an Ethernet network, process 800 proceeds to step s826.

At step s824, E-PMA disables the Ethernet card within CD 202. This may prevent CD 202 from joining an unwanted Ethernet network which may ensure that CD 202 only joins the networks identified within the network policy.

At step s826, E-PMA enables Ethernet card within CD 202. This enables CD 202 to connect to networks through an Ethernet network and can allow for faster network connection compared to other connects (e.g., 3GPP and/or W-Fi).

At step s828, E-PMA determines whether the current active network of CD 202 is most preferred. If the active network is not the most preferred, process 800 includes proceeding to step s830. If the active network is the most preferred, process 800 includes proceeding to step s840.

At step s830, CD 202 scans the other networks identified in the network policy and determines the connection strength of the other networks. In some embodiments, CD 202 may determine the network strength of each network identified in the network policy. In further embodiments, process 800 proceeds to step s832 once the network strength of all the other network is determined. In other embodiments, CD 202 can determine the network strength of each network sequentially in order of priority. In further embodiments, process 800 proceeds to step s832 once a network is found that meets the minimum network connection requirements (e.g., the quality of the preferred network is greater than threshold or not less than a threshold) the network is considered available.

In some embodiments, CD 202 can connect to each network to determine the network connection strength. In other embodiments, CD 202 can determine the network strength without joining the network (e.g., network strength is actively broadcast).

At step s832, E-PMA determines whether there are any available networks that correspond to higher priorities than the current active network. If no other network is available and/or if no available network is of a higher priority, the current active network of CD 202 will remain the active network and process 800 will proceed back to step s804. If there is at least one network that is available and at a higher priority than the current active priority, process 800 will proceed to step s834.

At step s834, E-PMA will select, from the available networks, the available network that is the highest in priority.

At step s836, E-PMA will set the selected available network to be the active network of CD 202. Process 800 will can then proceed again to the step s804.

At step s840, CD 202 will determine the connection status of the active network. In some embodiments, CD 202 can connect to each network to determine the network connection strength. In other embodiments, CD 202 can determine the network strength without joining the network (e.g., some networks actively broadcast their network strength).

At step s842, CD 202 will determine whether the active network connection is meets the minimum network connection requirements so as to be available (e.g., the quality of the preferred network is greater than threshold or not less than a threshold). If the active network is available, the current active network will remain the active network of CD 202 and process 800 will proceed again to step s804. If the current active network is not available, process 800 will proceed to step s844.

At step s844, CD 202 can scan the other networks identified in the network policy and determine the relative connection strength of each network. In some embodiments, CD 202 may determine the network strength of each network identified in the network policy. In other embodiments, CD 202 may determine the network strength of each network sequentially in order of priority

In some embodiments, CD 202 can connect to each network to determine the network connection strength. In other embodiments, CD 202 can determine the network strength without joining the network. Once the scan is completed, process 800 may proceed to step s834.

In some embodiments, the process 800 may be repeated after set a period. In other embodiments, MDMS may send trigger CD 202 to begin process 800 again. In other embodiments, process 800 may repeat after CD 202 moves from one geographical location to another. In yet other embodiments, process 800 may repeat once a new network policy is received.

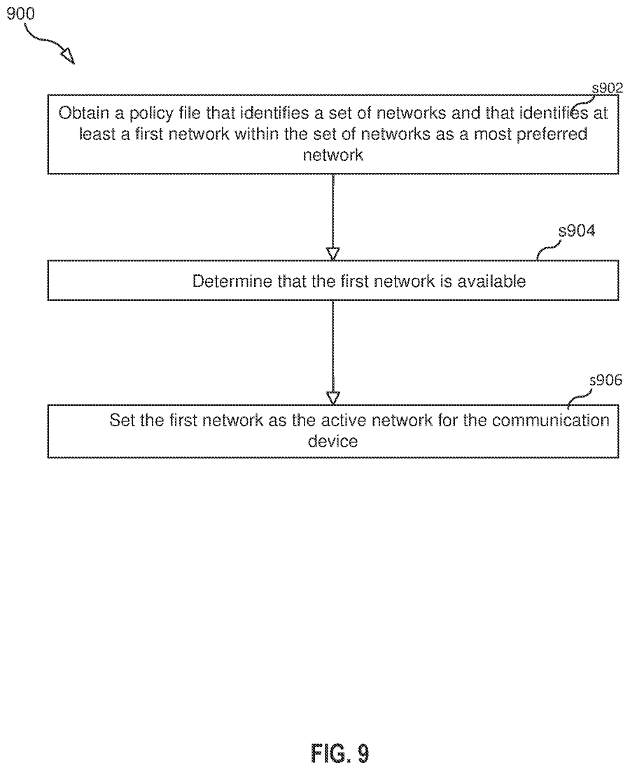

FIG. 9 a flowchart illustrating a process 900 performed by CD 202 for selecting an active network according to an embodiment. Process 900 may begin with step s902.

Step s902 E-PMA 604 obtaining a policy network policy that identifies a set of networks and that identifies at least a first network within the set of networks as a most preferred network.

Step s904 comprises E-PMA 604 determining that the first network is available.

Step s906 comprises E-PMA 604, as a result of determining that the first network is available, setting the first network as the active network for the communication device 202.

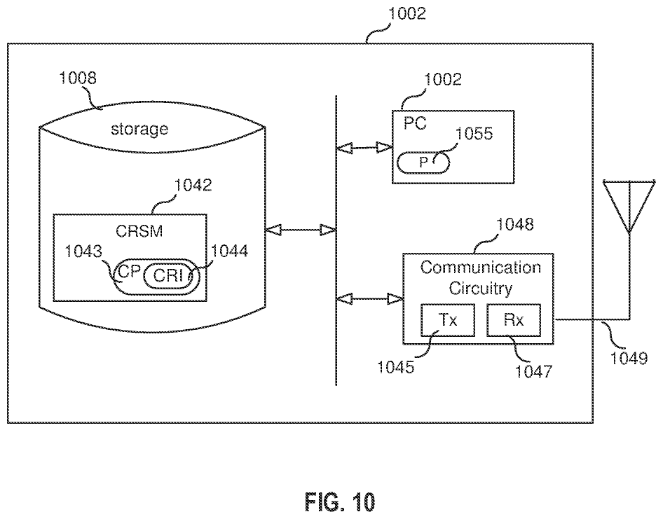

FIG. 10 is a block diagram of communication device (CD) 202, according to some embodiments. As shown in FIG. 10, CD 202 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like); communication circuitry 1048, which is coupled to an antenna arrangement 1049 comprising one or more antennas and which comprises a transmitter (Tx) 1045 and a receiver (Rx) 1047 for enabling CD 202 to transmit data and receive data (e.g., wirelessly transmit/receive data); and a storage unit (a.k.a., “data storage system”) 1008, which may include one or more non-volatile storage devices and/or one or more volatile storage devices. In embodiments where PC 1002 includes a programmable processor, a computer readable storage medium (CRSM) 1042 may be provided. CRSM 1042 may store a computer program (CP) 1043 comprising computer readable instructions (CRI) 1044. CRSM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes CD 202 to perform steps described herein (e.g., steps described herein with reference to the flow charts). In other embodiments, CD 202 may be configured to perform steps described herein without the need for code. That is, for example, PC 1002 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a communication device for selecting an available network to be an active network for the communication device, the method comprising:
obtaining a network policy that identifies a set of networks and that identifies at least a first network within the set of networks as a most preferred network, wherein the set of networks comprises a first third-generation partnership project (3GPP) network and a first non-3GPP network;
determining that the first network is available; and
as a result of determining that the first network is available, setting the first network as the active network for the communication device.

2. The method of claim 1, further comprising
determining that the network policy identifies an Ethernet network; and
as a result of determining that the network policy identifies the Ethernet network, enabling the communication device to use Ethernet networks.

3. The method of claim 1, further comprising determining that the first network is the most preferred network or one of the most preferred networks, wherein the determining comprises:
based on the network policy, determining, for each network identified in the set of available networks, a priority assigned to the network; and
based on the assigned priorities, determining that the first network has the highest priority.

4. The method of claim 1, wherein
the network policy assigns a first priority to the first set of networks,
the network policy identifies a second set of networks,
the network policy assigns a second priority to the second set of networks,
the method further comprises determining whether the first priority is higher than the second priority, and
the first network is set as the active network for the communication device as a result of determining that the first network is available and that the first priority is higher than the second priority.

5. The method of claim 1, wherein determining that the first network is available, comprises:
determining a quality of the first network based on one or more measurements of one or more signals transmitted by an access point belonging to the first network; and
determining whether the determined quality exceeds a quality threshold.

6. The method of claim 1, wherein
the first network is a 3GPP network,
a profile is associated with the first network, and
setting the first network as the active network for the communication device comprises activating the profile associated with the first network.

7. The method of claim 6, wherein
the first network is determined to be not available, and
the method comprises, after determining that the first network is not available, deactivating the profile associated with the first network.

8. The method of claim 1, wherein
the first network is determined to be not available, and
the method comprises, after determining that the first network is not available, setting another network from the set of networks to be the active network for the communication device.

9. The method of claim 8, further comprising:
before setting the another network to be the active network for the communication device, determining whether the communication device has an active session; and
as a result of determining that the communication device has an active session, waiting until after the active session is complete before setting the another network to be the active network for the communication device.

10. The method of claim 1, wherein obtaining the network policy comprises:
determining a geographic location of the communication device; and
selecting the network policy based on the determined geographic location.

11. A communication device, the communication device comprising:
a receiver;
a transmitter;
processing circuitry; and
memory, wherein the communication device is configured to perform a method comprising:
obtaining a network policy that identifies a set of networks and that identifies at least a first network within the set of networks as a most preferred network, wherein the set of networks comprises a first third-generation partnership project (3GPP) network and a first non-3GPP network;
determining that the first network is available; and
as a result of determining that the first network is available, setting the first network as the active network for the communication device.

12. The communication device of claim 11, wherein the method further comprises:
determining that the network policy identifies an Ethernet network; and
as a result of determining that the network policy identifies the Ethernet network, enabling the communication device to use Ethernet networks.

13. The communication device of claim 11, wherein
the method further comprises determining that the first network is the most preferred network or one of the most preferred networks, and
the determining comprises:
based on the network policy, determining, for each network identified in the set of available networks, a priority assigned to the network; and
based on the assigned priorities, determining that the first network has the highest priority.

14. The communication device of claim 11, wherein
the network policy assigns a first priority to the first set of networks,
the network policy identifies a second set of networks,
the network policy assigns a second priority to the second set of networks,
the method further comprises determining whether the first priority is higher than the second priority, and
the first network is set as the active network for the communication device as a result of determining that the first network is available and that the first priority is higher than the second priority.

15. The communication device of claim 11, wherein determining that the first network is available, comprises:
determining a quality of the first network based on one or more measurements of one or more signals transmitted by an access point belonging to the first network; and
determining whether the determined quality exceeds a quality threshold.

16. The communication device of claim 11, wherein
the first network is a 3GPP network,
a profile is associated with the first network, and
setting the first network as the active network for the communication device comprises activating the profile associated with the first network.

17. The communication device of claim 16, wherein
the first network is determined to be not available, and
the method comprises, after determining that the first network is not available, deactivating the profile associated with the first network.

18. The communication device of claim 11, wherein
the first network is determined to be not available, and
the method comprises, after determining that the first network is not available, setting another network from the set of networks to be the active network for the communication device.

19. The communication device of claim 18, further comprising:
before setting the another network to be the active network for the communication device, determining whether the communication device has an active session; and
as a result of determining that the communication device has an active session, waiting until after the active session is complete before setting the another network to be the active network for the communication device.

20. A non-transitory computer readable storage medium storing a computer program comprising instructions which when executed by processing circuitry of a communication device causes the communication device to perform the method of claim 1.
